(19) United States
(12) Patent Application Publication
(10) Pub. No.: US 2019/0032788 A1
(43) Pub. Date: Jan. 31, 2019

(54) MECHANICAL SEAL ARRANGEMENT OF A HYDRODYNAMIC RETARDER AND HYDRODYNAMIC RETARDER

(71) Applicants: Carl Freudenberg KG, Weinheim (DE); EagleBurgmann Germany GmbH & Co. KG, Wolfratshausen (DE)

(72) Inventors: Clemens Simon, Weilheim (DE); Uwe Braun, Lutzelsachsen (DE); Klaus Lang, Beuerberg (DE)

(21) Appl. No.: 16/046,624

(22) Filed: Jul. 26, 2018

(30) Foreign Application Priority Data
Jul. 31, 2017 (DE) 102017213148.9

(51) Int. Cl. F16J 15/34; F16D 57/00

(52) U.S. Cl. CPC F16J 15/3404; F16D 57/00

(57) ABSTRACT

The invention relates to a mechanical seal arrangement, in particular a retarder-mechanical seal arrangement, comprising a first mechanical seal (2) with a first rotating slide ring (3) and a first stationary slide ring (4) which define a first sealing gap (5) in between them, an additional seal (6), a cooling medium space (7) which is filled with a cooling medium and extends all the way to the sealing gap of the first mechanical seal (2), wherein the first mechanical seal (2) seals the cooling medium space against an environment, a cooling medium access (8) into the cooling medium space (7) for supplying cooling medium, and a cooling medium exit (9) from the cooling medium space (7) for draining cooling medium, wherein the additional seal (6) is arranged in the cooling medium access (8), and wherein the additional seal (6) is configured to open when a pressure inside the cooling medium access (8) rises above a first pressure (P1) inside the cooling medium space (7), and to close at a second pressure (P0) inside the cooling medium access (8) that is lower than the first pressure (P1) inside the cooling medium space.

The invention relates to a mechanical seal arrangement of a hydrodynamic retarder as well as to a hydrodynamic retarder with a mechanical seal arrangement.

Hydrodynamic retarders are used in drives of vehicles, in particular in trucks or buses, or the like. At that, the retarder is switched on or off by filling and emptying a retarder work space inside of which a stator wheel and a rotor wheel connected to a retarder shaft are arranged. The working fluid is a liquid, usually oil or water. In vehicles, the retarder is usually used for braking. For sealing the retarder against the environment, a mechanical seal may be used, for example. The problem that arises here is that, during non-operation of the retarder, i.e. when no liquid is present in the retarder space and e.g. the vehicle does not brake for an extended period of time, the amount of lubricating medium provided by the retarder liquid which is present at the mechanical seal is insufficient. In this manner, a so-called dry running of the mechanical seal may occur, which results in excessive heat generation at the mechanical seal, and in an extreme case can lead to damage to the mechanical seal, or its failure.

Therefore, it is the objective of the present invention to provide a mechanical seal arrangement of a hydrodynamic retarder that is characterized by a longer service life and a reduced danger of failure of the mechanical seal, while at the same time having a simple structure and being easy and cost-effective to manufacture. Further, it is the objective of the present invention to provide a hydrodynamic vehicle retarder which comprises an improved and long-life seal at the retarder shaft.

This objective is achieved through a mechanical seal arrangement with the features of claim 1 and a hydrodynamic retarder with the features of claim 12. The subclaims respectively indicate preferred embodiments of the invention.

The mechanical seal arrangement according to the invention with the features of claim 1 has the advantage that sufficient lubrication of the mechanical seal arrangement is ensured. In this manner, a sufficient lubrication and cooling of the mechanical seal arrangement can be immediately facilitated also in the event of longer non-operation of the retarder, for example if a vehicle is driven on a motorway for a longer period of time without any braking operations being performed. Thus, the mechanical seal arrangement has a significantly higher service life as compared to the state of the art as it has been known so far. In this manner, it is possible to ensure that a sufficient amount of a liquid cooling medium and/or lubricating medium is present close to a sealing gap of the mechanical seal arrangement. In the following, the term “cooling medium” is used consistently, with this term “cooling medium” referring to a medium that has cooling properties as well as lubricating properties. Accordingly, the cooling medium takes over the cooling of the mechanical seal arrangement, as well as the necessary lubrication in the area of sliding surfaces of the mechanical seal arrangement. The cooling medium is preferably an oil. According to the invention, a cooling medium space is provided, which is filled with cooling medium in every operational state of the retarder in order to supply cooling medium to a sealing gap of the mechanical seal arrangement. Here, the mechanical seal arrangement of a retarder according to the invention comprises a first mechanical seal with a rotating slide ring and a stationary slide ring which define a sealing gap in between them. Further, the mechanical seal arrangement comprises an additional seal, i.e. a second seal, as well as the cooling medium space that is filled with cooling medium and extend all the way to the sealing gap of the first mechanical seal. Here, the first mechanical seal seals the cooling medium space against an environment area. What is further provided is a cooling medium access and a cooling medium exit into and out of the cooling medium space. The cooling medium access is provided for supplying cooling medium and is configured for connecting the cooling medium space with a retarder work space. The cooling medium exit is provided for draining cooling medium from the cooling medium space. Here, the additional seal is arranged inside the cooling medium access, sealing the cooling medium space against the retarder work space, for example. At that, the additional seal is configured in such a manner that the additional seal is opened if a pressure increase above a first pressure P1 in the cooling medium space occurs in the cooling medium access, i.e. for example a pressure rises in the retarder work space, so that cooling medium is supplied from the retarder work space via the cooling medium access into the cooling medium space. Further, the additional seal is configured in such a manner that the additional seal closes in the event of a pressure inside the cooling medium access that is lower than the first pressure P1 in the cooling medium space, thus separating the cooling medium space from the cooling medium access.

By providing a cooling medium space that is filled with cooling medium in every operational state adjacent to the sealing gap of the first mechanical seal, it can thus be ensured that a sufficient lubrication of the sealing gap with cooling medium is possible, so that a service life of the mechanical seal arrangement, e.g. of a retarder, can be significantly prolonged. Further, through the exchange of the cooling medium inside the cooling medium space during operation of the retarder, i.e. when the pressure inside the retarder work space is higher than the pressure inside the cooling medium space, an exchange of the cooling medium can occur inside the cooling medium space, so that a sufficient heat dissipation from the mechanical seal arrangement is also possible.

Preferably, a closing element is arranged in the cooling medium exit to open and close the cooling medium exit. In this manner, it can be ensured that a sufficient amount of cooling medium remains inside the cooling medium space.

It is particularly preferred if the closing element is a pressure-controlled check valve. In this way, an automatic opening of the check valve can be facilitated as soon as a first pressure P1 inside the cooling medium space rises above a pre-defined pressure that is necessary for opening of the check valve. Such check valves are very cost-effective and can ensure a reliable opening and closing of the cooling medium exit.

A particularly cost-effective and simple mechanical seal arrangement can be provided if the additional seal is preferably a lip seal. The lip seal is preferably made of an elastic material, preferably an elastomer. It can be provided in a cost-effective manner and with a very high degree of operational reliability. In addition to the sealing function, the lip seal also takes over a valve function here, namely by the lip seal lifting off of the sealing surface at which a sealing lip of the lip seal abuts if a pressure outside of the cooling medium space increases, thus creating a connection to the cooling medium space. Preferably, the lip seal has exactly one sealing lip with which the lip seal abuts and seals at the sealing surface. The opening of the lip seal occurs due to elastic deformation of the lip seal, whereby it is achieved that the sealing surface lifts off.

It is particularly preferred if the lip seal seals at an outer circumferential area of the rotating slide ring. In this manner, a particularly compact and space-saving structure can be obtained.

According to another preferred embodiment of the present invention, the additional seal is a second mechanical seal. The second mechanical seal has an axially displaceable slide ring. In this way, the sealing gap can be enlarged by an axial movement of the axially displaceable slide ring, so that it is made possible for the second mechanical seal to open. It is particularly preferred if the axially displaceable slide ring is the stationary slide ring of the second mechanical seal.

A particularly compact and simple structure is possible if the first rotating slide ring of the first mechanical seal and the second rotating slide ring of the second mechanical seal are integrated in a single common structural component. In that case, this common structural component has a first sliding surface for the first mechanical seal and a second sliding surface for the second mechanical seal. Preferably, a recess is provided between the two sliding surfaces, e.g. a groove or the like for separating the two sliding surfaces.

It is particularly preferred if the two sliding surfaces of the first and second mechanical seal are arranged at the common structural component at the same side of the common structural component.

Further, the axially displaceable slide ring of the second mechanical seal preferably has a sealing surface that is oriented towards the cooling medium access and at the same time is also oriented in the axial direction, namely in such a manner that an axial displacement of the axially displaceable slide ring occurs if the pressure outside the cooling medium space is higher than the one present in the cooling medium space itself. Thus, opening of the second mechanical seal can be automatically facilitated through a surface at the axially displaceable slide ring. At that, the surface can be oriented perpendicular to an axial direction of the mechanical seal, or can also be oriented at an acute angle to the axial direction. Here, the opening characteristics of the second mechanical seal can be determined based on the selection of the size of the control surface at the axial displaceable slide ring. It is particularly preferred if the control surface is provided by a ledge at the axially displaceable slide ring.

Further, it is preferred if the cooling medium space is arranged inside a housing component with a C-shaped cross section. In this manner, it is made possible for the mechanical seal arrangement to be provided as a pre-assembled assembly group, so that it can for example be supplied as a supplier part, for example for installation in a retarder.

Further, it is preferred that the first mechanical seal and the second mechanical seal of the mechanical seal arrangement are arranged in series in the axial direction as a so-called tandem seal.

Further, the present invention relates to a hydrodynamic retarder, comprising a retarder shaft, a stator wheel, a rotor wheel, a retarder housing and a mechanical seal arrangement according to the invention. Preferably, the mechanical seal arrangement is arranged in the axial direction directly adjacent to the hydrodynamic retarder and sealing directly at the retarder shaft.

In the following, preferred exemplary embodiments of the invention are described in detail by referring to the accompanying drawing. In the drawing:

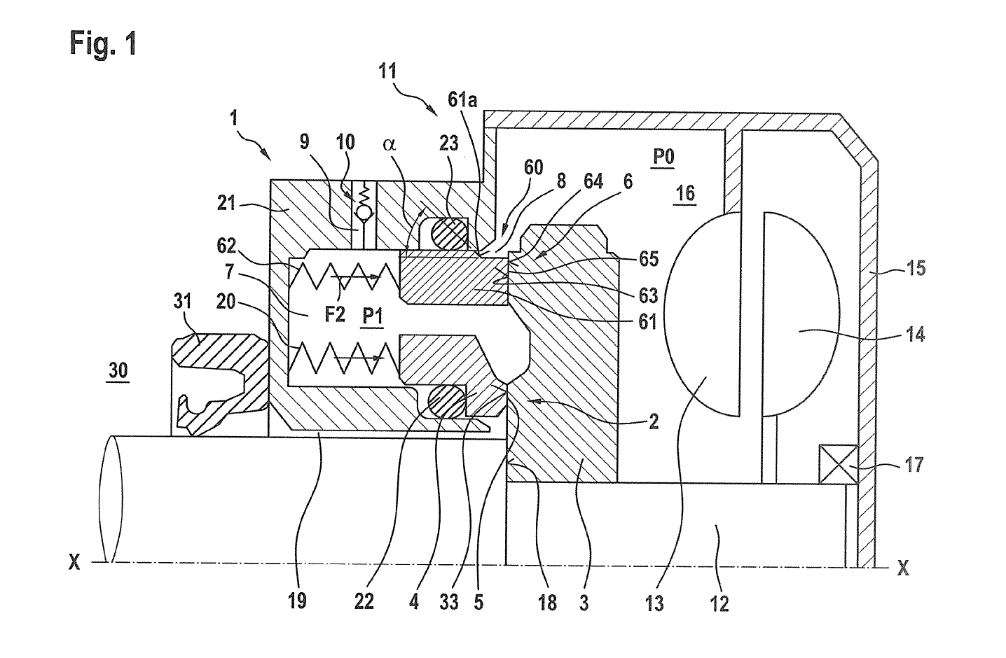

FIG. 1 shows a schematic sectional view of a hydrodynamic retarder with a mechanical seal arrangement according to a first exemplary embodiment of the invention, wherein the retarder is not in operation;

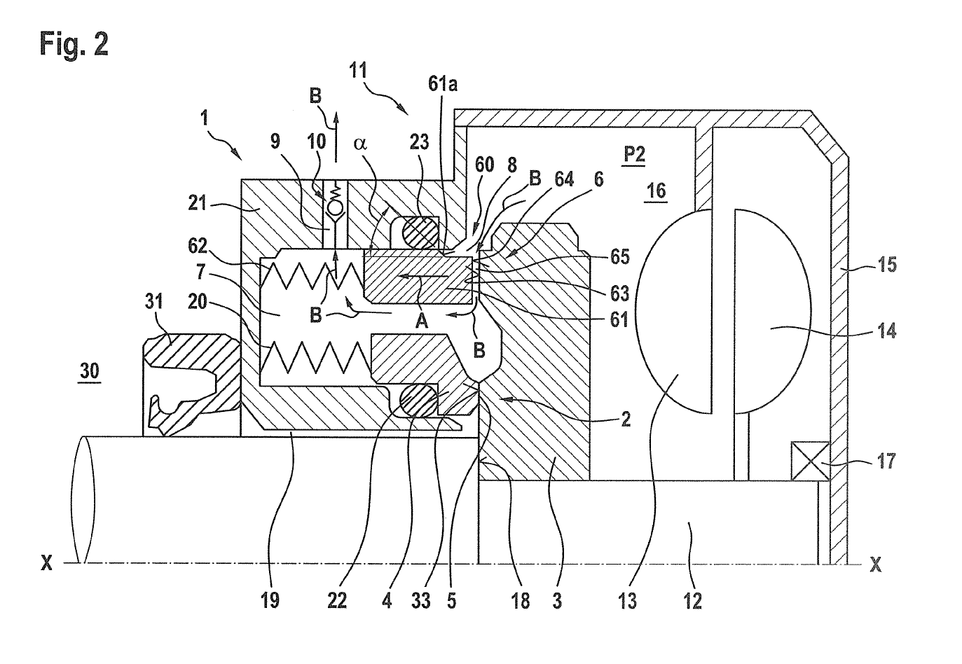

FIG. 2 shows a schematic sectional view of the mechanical seal arrangement of the retarder of FIG. 1, wherein the retarder is in operation;

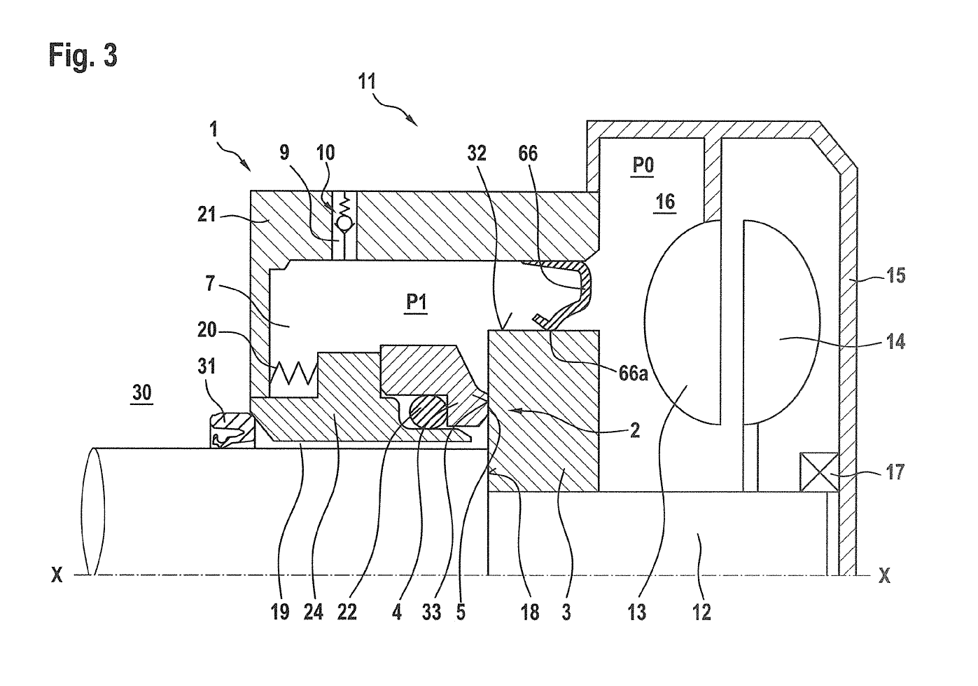

FIG. 3 shows a schematic sectional view of a mechanical seal arrangement of a hydrodynamic retarder according to a second exemplary embodiment of the invention, wherein the retarder is not in operation; and

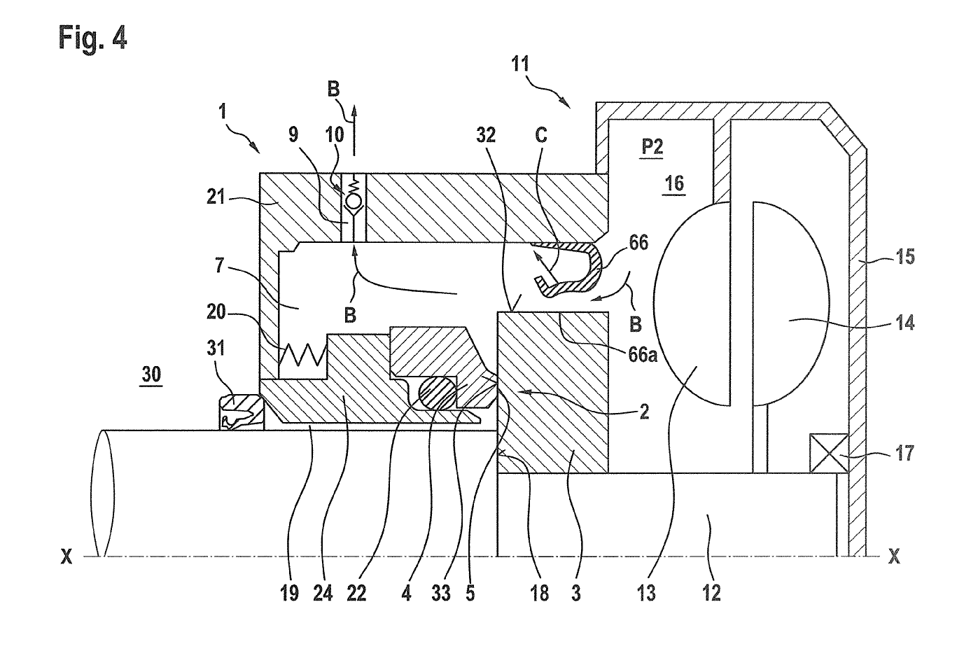

FIG. 4 shows a schematic sectional view of the mechanical seal arrangement of FIG. 3, wherein the retarder is in operation.

In the following, a mechanical seal arrangement 1 as well as a hydrodynamic retarder 11 according to a first preferred exemplary embodiment of the invention are described in detail by referring to FIGS. 1 and 2.

FIG. 1 shows a sectional view of a retarder 11, which comprises a retarder shaft 12, a stator wheel 13, a rotor wheel 14, and a retarder housing 15. The retarder housing 15 encloses a retarder work space 16. At that, the stator wheel 13 is attached at the retarder housing 15. The rotor wheel 14 is connected to a retarder shaft 12. Reference sign 17 indicates a bearing (floating mounting) at which the retarder shaft 12 is mounted.

The hydrodynamic retarder may for example be used in vehicles, in particular in trucks or busses, or the like. Here, braking work, i.e. a conversion into heat, is performed by the retarder by filling the retarder work space 16 with a liquid, for example with oil. After a braking operation has been performed, the liquid is drained from the retarder work space 16 again.

Now a mechanical seal arrangement according to the invention 1 seals at the retarder shaft 12. Here, the retarder shaft 12 has a shaft shoulder 18 at which the mechanical seal arrangement 1 is arranged.

The mechanical seal arrangement 1 comprises a first mechanical seal 2 with a first rotating slide ring 3 (counter ring) and a first stationary slide ring 4 which define a sealing gap 5 in between them. Here, the mechanical seal arrangement 1 seals the retarder work space 16 against an environment 30.

The mechanical seal arrangement 1 further comprises an additional seal 6, which in this exemplary embodiment is embodied as a second mechanical seal 60. The second mechanical seal 60 comprises a second stationary slide ring 61, wherein the rotating slide ring 3 of the first mechanical seal 2 also provides a sliding surface 63 of the second rotating slide ring for the second mechanical seal 60. As can be seen in FIG. 1, the rotating slide rings of the first [and] second mechanical seal 2, 60 are integrated in a common structural component (indicated by reference sign 3). Thus, the rotating slide ring 3 has two sliding surfaces, namely a first sliding surface 33 for the first mechanical seal 2 and a second sliding surface 63 for the second mechanical seal 60.

Further, the first mechanical seal arrangement 1 has a cooling medium space 7. The cooling medium space 7 is provided to supply a cooling medium, which is also used as a lubricating medium, at the first mechanical seal 2 in a continuous manner, i.e. in every operational state of the retarder. This has the advantage that it is ensured that cooling medium is always present at the first and second mechanical seal 2, 60 to lubricate and cool the mechanical seals.

The cooling medium space 7 is arranged inside a housing 21 of the first mechanical seal 2. The housing 21 has a substantially C-shaped cross section, with the cooling medium space 7 being formed inside it. The cooling medium space 7 is provided with a supply area for fresh cooling medium via a cooling medium access 8, in this exemplary embodiment directly from the retarder work space 16, as well as with a cooling medium exit 9.

As can be seen in FIG. 1, the cooling medium exit 9 is arranged directly inside the housing 21. Here, a closing element 10 in the form of an independently opening check valve is arranged in the cooling medium exit 9. The check valve opens as soon as a first pressure P1 inside the cooling medium space 7 becomes higher than in an area in flow direction (arrow B) behind the check valve (cf. FIG. 2).

The first mechanical seal 2 further has a first pre-stressing element 20 that exerts a pre-stress on the first stationary slide ring 4 in the axial direction X-X, in particular a pre-stress of approx. 100 N. Further, an O-ring 22 for sealing at the housing 21 of the mechanical seal arrangement is provided at the first stationary slide ring 4.

A second pre-stressing element 62 is arranged at the second mechanical seal 60 at the second stationary slide ring 61 to provide a pre-stress of the stationary second slide ring 61 of the second mechanical seal in the axial direction X-X.

Thus, in this exemplary embodiment, the second mechanical seal 60 is provided by a partial area of the rotating slide ring 3 that comprises the first sliding surface 33 for the first mechanical seal 2 and the second sliding surface 63 for the second mechanical seal 60. Further, the second mechanical seal 60 has a sliding surface 64 at the second stationary slide ring 61, so that the sealing gap 65 is formed between the sliding surface 64 and the sliding surface 63 of the second mechanical seal 60.

As can further be seen in FIG. 1, a control surface 61a is provided at the stationary slide ring 61. The control surface 61a is formed by a ledge at the stationary slide ring 61. At that, the control surface 61a is oriented in the direction towards the cooling medium access 8, so that it is connected to the retarder work space 16. The control surface 61a is arranged at an acute angle α with respect to the sealing gap 65 of the second mechanical seal 60, preferably at an angle of 45°. In this manner, it is achieved that a pressure inside the cooling medium access 8 can exert a partial axial force on the stationary slide ring 61 via the oblique control surface 61a.

The stationary slide ring 61 of the second mechanical seal 60 is sealed with respect to the housing 21 of the mechanical seal arrangement 1 by means of an O-ring 23.

What is further provided is an environmental seal 31 in the form of an elastomeric seal, which is arranged at the housing 21 of the mechanical seal arrangement 1 and which facilitates sealing of a gap between the housing 21 and the retarder shaft 12 against the environment 30.

The function of the mechanical seal according to the invention 1 of the first exemplary embodiment is as follows. When liquid is supplied into the retarder work space 16 in the event of operation, i.e. when the retarder 11 is active, and the retarder performs braking work, a pressure inside the retarder work space 16 rises from a pressure P0 in FIG. 1 to the pressure P2 in FIG. 2. In the case that the retarder does not work, the pressure P0 inside the retarder work space 16 is lower than a first pressure P1 inside the cooling medium space 7. If now the pressure inside the retarder work space 16 rises above the first pressure P1, an axial movement of the stationary slide ring 61 of the second mechanical seal 60 can be facilitated. At that, the rising pressure P2 (cf. FIG. 2) inside the retarder work space 16 exerts a force A on the control surface 61a at the stationary slide ring 61 that acts in the axial direction, so that the stationary slide ring 61 is moved in the axial direction X-X against the pre-stressing force of the second pre-stressing element 62. As a result, the sealing gap 65 of the second mechanical seal 60 is enlarged, so that a medium can flow from the retarder work space 16 into the cooling medium space 7, as indicated in FIG. 2 by the arrows B. As a result, a pressure inside the cooling medium space 7 is likewise increased, so that, from certain pressure level upwards, the closing element 10 in the form of the check valve in the cooling medium exit 9 is opened, so that cooling medium is conducted from the retarder work space 16 through the cooling medium space 7 back to a cooling medium reservoir. In this manner, also a cooling of the first mechanical seal 1 is facilitated.

If the retarder 11 is not supposed to work any longer, the liquid is drained from the retarder work space 16, so that the pressure inside the retarder work space 16 drops back to pressure P0 and the retarder work space 16 is emptied. Then, the second pre-stressing element 62 sets the stationary slide ring 61 back into the initial position, as indicated in FIG. 1 by arrow F2. Since the pressure inside the cooling medium space 7 drops, the closing element 7 also closes automatically as a result of the spring load.

In this manner, it is ensured that, even during non-operation of the retarder 11, there is always a sufficient amount of cooling medium present inside the cooling medium space 7 enclosed by the closing element 10 as well as the second mechanical seal 60 and the first mechanical seal 2. In this manner, it can in particular be avoided that the first mechanical seal 2 falls dry, so that the mechanical seal arrangement 1 can have a significantly longer service life. In addition to the sealing function for sealing the cooling medium space 7, the second mechanical seal 60 also takes over a valve function here so as to enlarge the sealing gap 65 of the second mechanical seal 60 in such a manner that a sufficient amount of cooling medium can flow into the cooling medium space 7 during the retarder operation. Thus, in particular when used with a retarder, the mechanical seal arrangement according to the invention 1 can ensure a reliable seal without a separate cooling medium supply during start up or shutdown of the retarder.

It is to be understood that, in the event of a change in the retarder work space 16, the opening characteristics of the second mechanical seal can be adjusted by setting a pre-stressing force of the second pre-stressing element 62 or by choosing the size of the control surface 61a at the stationary slide ring 61 of the second mechanical seal 60.

FIGS. 3 and 4 show a mechanical seal arrangement 1 according to a second exemplary embodiment of the invention, wherein the same or functionally identical parts are indicated by the same reference signs.

In the second exemplary embodiment, the mechanical seal arrangement 1 has a lip seal 66 instead of a second mechanical seal as the additional seal. The lip seal 66 is made of an elastomeric material and has a sealing lip 66a, which seals at a radially outer circumference of the rotating slide ring 3 of the first mechanical seal 2. Here, FIG. 3 in turn shows the sealing state of the additional seal, so that the cooling medium space 7 is filled with cooling medium and sealed to ensure the lubrication of the first mechanical seal 2. The lip seal 66 is preferably made of an elastomeric material.

As can further be seen from FIG. 3, the first mechanical seal 2 comprises a sleeve 24 which is arranged at the stationary slide ring 4 of the first mechanical seal 2 and via which a pre-stressing force of the first pre-stressing element 20 is transferred to the stationary slide ring 4.

If now, due to the supply of cooling medium, a pressure inside the retarder work space 16 rises from an initial pressure P0 shown in FIG. 3 (retarder has no cooling medium or working fluid) to a pressure P2 (FIG. 4), the lip seal 66 is elastically deformed, so that the sealing lip 66a lifts off of the radially outer circumference 32 of the rotating slide ring 3. As a result, a flow of cooling medium from the retarder work space 16 into the cooling medium space 7 is facilitated, as indicated in FIG. 4 by the arrows B. The elastic deformation of the lip seal 66 is also indicated in FIG. 4 by arrow C. The second exemplary embodiment can be provided in a particularly cost-effective manner because a cost-saving lip seal 66 may be used instead of a second mechanical seal. As shown in FIGS. 3 and 4, the lip seal 66 is connected to the housing 21 of the cooling medium space 7 via an additional structural component. Thus, the lip seal 66 again takes over a valve function as well as a sealing function, so that a sufficient amount of cooling medium, in particular for lubricating the first mechanical seal 2, is always present inside the cooling medium space 7.

The present invention has been described in the context of a hydrodynamic retarder. It is to be understood that the mechanical seal arrangement according to the invention 1 can also be used in other devices with rotating shafts and liquids, for example in pumps.

### PARTS LIST

1 mechanical seal arrangement
2 first mechanical seal
3 rotating slide ring
4 stationary slide ring
5 sealing gap
6 additional seal
7 cooling medium space
8 cooling medium access
9 cooling medium exit
10 closing element/check valve
11 retarder
12 retarder shaft
13 stator wheel
14 rotor wheel
15 retarder housing
16 retarder work space
17 bearing
18 shaft shoulder
19 gap
20 first pre-stressing element
21 housing of the mechanical seal arrangement
22 O-ring
23 O-ring
24 sleeve
30 environment
31 environmental seal
32 radially outer circumference of the rotating slide ring
333 first sliding surface of the first rotating slide ring 3
60 second mechanical seal
61 stationary slide ring
61a control surface
62 second pre-stressing element
63 second sliding surface of the rotating slide ring
64 sliding surface of the second stationary slide ring
65 sealing gap
66 lip seal
66a sealing lip
A axial movement of the second stationary slide ring 61
B flow of the cooling medium in and out of the cooling medium space
C movement of the sealing lip
P0 pressure inside the retarder work space without retarder operation
P1 pressure inside the cooling medium space
P2 pressure inside the retarder work space with retarder operation
X-X axial direction of the mechanical seal arrangement
α angle of the control surface 61a

1. Mechanical seal arrangement, in particular retarder-mechanical seal arrangement, comprising
a first mechanical seal with a first rotating slide ring and a first stationary slide ring which define a first sealing gap in between them,
an additional seal,
a cooling medium space filled with a cooling medium and extending to the sealing gap of the first mechanical seal,
wherein the first mechanical seal seals the cooling medium space against an environment,
a cooling medium access into the cooling medium space for supplying cooling media, and
a cooling medium exit from the cooling medium space for draining a cooling medium,
wherein the additional seal is arranged inside the cooling medium access, and
wherein the additional seal is configured to open when a pressure inside the cooling medium access increases above a first pressure inside the cooling medium space, and to close at a second pressure inside the cooling medium access, which is lower than the first pressure inside the cooling medium space.

2. Mechanical seal arrangement according to claim 1, wherein a closing element for opening and closing the cooling medium exit is arranged in the cooling medium exit.

3. Mechanical seal arrangement according to claim 2, wherein the closing element is a check valve.

4. Mechanical seal arrangement according to claim 1, wherein the additional seal is a lip seal.

5. Mechanical seal arrangement according to claim 4, wherein the lip seal has a sealing lip, and wherein the lip seal seals with the sealing lip at an outer circumferential area of the rotating slide ring.

6. Mechanical seal arrangement according to claim 1, wherein the additional seal is a second mechanical seal that has an axially displaceable slide ring.

7. Mechanical seal arrangement according to claim 6, wherein the axially displaceable slide ring is a second stationary slide ring of the second mechanical seal.

8. Mechanical seal arrangement according to claim 7, wherein the first rotating slide ring of the first mechanical seal and the second rotating slide ring of the second mechanical seal are integrated in a single common structural component with a first sliding surface and a second sliding surface.

9. Mechanical seal arrangement according to claim 8, wherein the first sliding surface and the second sliding surface are arranged at the same side of the common structural component.

10. Mechanical seal arrangement according to claim 6, wherein the axially displaceable slide ring has a control surface that is oriented towards the cooling medium access and in the axial direction, namely in such a manner that the axially displaceable slide ring performs an axial movement in the event that a pressure inside the cooling medium access is higher than a first pressure inside the cooling medium space.

11. Mechanical seal arrangement according to claim 1, wherein the cooling medium space is arranged inside a housing having a C-shaped cross section.

12. Hydrodynamic retarder, comprising: a retarder shaft, a stator wheel, a rotor wheel, a retarder housing, and a mechanical seal arrangement according to claim 1.

13. Hydrodynamic retarder according to claim 12, wherein the mechanical seal arrangement seals directly at the retarder shaft.

14. Hydrodynamic retarder according to claim 12, further comprising an environmental seal, in particular an elastomeric environmental seal that seals between the mechanical seal arrangement and the retarder shaft.
